(19) United States
(12) Patent Application Publication
(10) Pub. No.: US 2025/0146768 A1
(43) Pub. Date: May 8, 2025

(54) HEADER TUBE, HEAT EXCHANGER, AIR CONDITIONER, AND METHOD FOR MANUFACTURING HEADER TUBE

(71) Applicant: Mitsubishi Electric Corporation, Chiyoda-ku, Tokyo (JP)

(72) Inventors: Kota INAMI, Chiyoda-ku, Tokyo (JP); Takashi NAKAJIMA, Chiyoda-ku, Tokyo (JP); Norio KATSUMA, Chiyoda-ku, Tokyo (JP); Yuriko OKUMA, Chiyoda-ku, Tokyo (JP)

(73) Assignee: Mitsubishi Electric Corporation, Chiyoda-ku, Tokyo (JP)

(21) Appl. No.: 18/838,400

(22) PCT Filed: Mar. 10, 2023
(86) PCT No.: PCT/JP2023/009267

§ 371 Date: Aug. 14, 2024

(30) Foreign Application Priority Data
Mar. 11, 2022 (JP) 2022-037966

(51) Int. Cl. F28F 9/02

(52) U.S. Cl. CPC F28F 9/026

(57) ABSTRACT

An upper header tube according to the present disclosure is connectable to heat transfer tubes arranged in parallel to each other, and is capable of constituting a heat exchanger together with the heat transfer tubes. The upper header tube includes a first member including a bottom plate and a pair of lateral plates standing at opposed edges of the bottom plate, a second member disposed apart from the bottom plate, held between the pair of lateral plates, and bonded to the first member by brazing, and tab members disposed at the edges of the pair of lateral plates of the first member. The tab members are bent relative to the lateral plate so as to face the second member. Each of the tab members is tapered toward the tip in plan view.

### TECHNICAL FIELD

The present disclosure relates to a header tube, a heat exchanger, an air conditioner, and a method of manufacturing a header tube.

### BACKGROUND ART

Air conditioners accommodate refrigerant circulating between an indoor unit and an outdoor unit and thus heat or cool the indoor air. Each of the indoor unit and the outdoor unit of the air conditioner includes a heat exchanger. The heat exchanger causes heat exchange between refrigerant and the environment surrounding the indoor unit or the outdoor unit. The heat exchanger includes a heat transfer tube array including multiple heat transfer tubes, and header tubes connected to the heat transfer tube array.

Some header tubes included in heat exchangers have been known each manufactured through bonding multiple members to each other by brazing. For example, Patent Literature 1 discloses a heat exchanger, which includes a header tube manufactured through bonding a first member including a bottom plate and a pair of lateral plates to a second member by brazing. Each of the lateral plates is provided with tab members at the edge adjoining the second member, and the tab members are bent to come into contact with the second member.

### CITATION LIST

### Patent Literature

Patent Literature 1: Unexamined Japanese Patent Application Publication

### SUMMARY OF INVENTION

### Technical Problem

The air conditioner needs to have a structure in which refrigerant circulating in the air conditioner does not leek during circulation. In order to prevent leakage of refrigerant, the first member and the second member must be air-tightly bonded to each other in the header tube disclosed in Patent Literature 1.

The header tube disclosed in Patent Literature 1, however, suffers from a problem that the gaps between the tab members and the second member are expanded at the tips of the tab members due to springback behaviors occurring after bending of the tab members. Such expanded gaps between the tab members and the second member may fail to retain droplets of a molten brazing material in the brazing process. These droplets of the brazing material may run downward and fail to be sufficiently distributed across the joint between the first member and the second member. The joint between the first member and the second member may accordingly have inferior airtightness. That is, the header tube disclosed in Patent Literature 1 cannot readily achieve an airtight structure at the joint between the first member and the second member in the manufacturing process.

The present disclosure is made in view of the above problems, and an objective of the present disclosure is to provide a header tube that is manufactured by bending tab members of one member over the other member and thus fixing the other member relative to the one member, and then bonding these members to each other by brazing, and that can readily achieve an airtight structure in the manufacturing process.

Another objective of the present disclosure is to provide a heat exchanger and an air conditioner including the above-described header tube. Still another objective of the present disclosure is to provide a method of manufacturing the above-described header tube.

### Solution to Problem

In order to achieve the above objective, a header tube according to the present disclosure is connectable to heat transfer tubes arranged in parallel to each other, and is capable of constituting a heat exchanger together with the heat transfer tubes. The header tube according to the present disclosure includes: a first member including a bottom plate and a pair of lateral plates standing at opposed edges of the bottom plate; a second member disposed apart from the bottom plate, held between the pair of lateral plates, and bonded to the first member by brazing; and tab members disposed at edges of the pair of lateral plates of the first member. The tab members are bent relative to the lateral plate so as to face the second member. Each of the tab members is tapered toward the tip in plan view.

### ADVANTAGEOUS EFFECTS OF INVENTION

In the header tube according to the present disclosure, droplets of a molten brazing material, which is preliminarily cladded on the surface of a tab member to come into contact with the second member, run downward in the brazing process. The droplets of the molten brazing material are accumulated into a large thickness at the tip of the tab member, and thus readily come into contact with the second member. The accumulated brazing material can prevent a crack from being generated at the brazed joint due to the absence of the brazing material. The present disclosure can therefore provide a header tube that can readily achieve an airtight structure in the manufacturing process.

### BRIEF DESCRIPTION OF DRAWINGS

FIG. 1 is an explanatory diagram illustrating a fundamental configuration of an air conditioner according to the embodiment;

FIG. 2A is a front view illustrating a fundamental configuration of a heat exchanger included in the air conditioner illustrated in FIG. 1;

FIG. 2B is a side view of the heat exchanger;

FIG. 3A is a transverse sectional view of an upper header tube of the heat exchanger illustrated in FIGS. 2A and 2B taken along the plane represented by the line I-I of FIG. 2A;

FIG. 3B is a longitudinal sectional view of a part of the upper header tube taken along the plane represented by the line II-II of FIG. 2B;

FIG. 4A is a perspective view illustrating the external shape of a first member that constitutes the upper header tube of the heat exchanger illustrated in FIGS. 2A and 2B, before fitting of a second member to the first member and bending of tab members;

FIG. 4B is a perspective view of the first member after fitting of the second member to the first member;

FIG. 4C is an enlarged view of one of the tab members of the first member as seen in the direction represented by the arrow A of FIG. 4A;

FIG. 5 is a transverse sectional view of the upper header tube for describing functions of the tab members;

FIG. 6 is a transverse sectional view illustrating the upper header tube after a brazing process in conformity with FIG. 5;

FIG. 7A is a front view illustrating the shape of a test piece that imitates the tab member of the first member illustrated in FIGS. 4A to 4C before an examination;

FIG. 7B is a side view illustrating the shape of the test piece after the examination;

FIG. 7C is a graph illustrating a relationship between the ratio of the diameter of the semicircular tip of the test piece to the width of the proximal portion of the test piece and the height of a lump of a brazing material formed at the tip of the test piece;

FIG. 7D is a front view illustrating the shape of another test piece before an examination;

FIG. 7E is a side view illustrating the shape of the other test piece after the examination;

FIG. 8A is a plan view illustrating the shape of a tab member according to Modification 1 of the present disclosure;

FIG. 8B is a plan view illustrating the shape of a tab member according to Modification 2 of the present disclosure;

FIG. 9 is a transverse sectional view illustrating the structure of an upper header tube according to Modification 3 of the present disclosure in conformity with FIG. 5;

FIG. 10A is a perspective view illustrating the shape of a first member according to Modification 4;

FIG. 10B is a perspective view illustrating the shape of an end plate according to Modification 4;

FIG. 10C is a perspective view of the first member after fitting of the end plate to the first member;

FIG. 10D is a perspective view of the first member after fitting of the end plate and a second member to the first member and bending of tab members;

FIG. 10E is an explanatory diagram illustrating the shapes of the tab members and an engaging notch of the first member according to Modification 4, in conformity with FIG. 4C; and

FIG. 11 is an explanatory diagram illustrating the shapes of tab members and notches of a first member according to Modification 5, in conformity with FIG. 4C.

### DESCRIPTION OF EMBODIMENTS

The following describes configurations and effects of a header tube, a heat exchanger, and an air conditioner according to some embodiments of the present disclosure in detail, with reference to the accompanying drawings. In each of the drawings, the components identical or corresponding to each other are provided with the same reference symbol.

### Air Conditioner

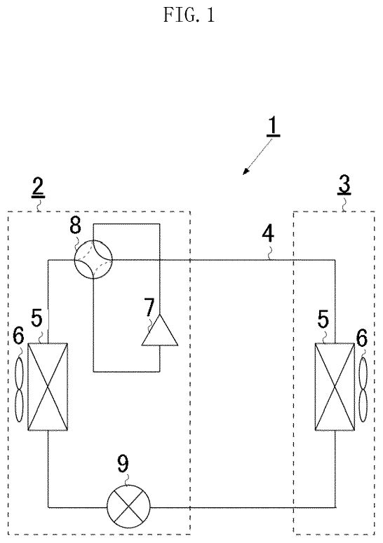

FIG. 1 is an explanatory diagram illustrating a fundamental configuration of an air conditioner 1 according to an embodiment. The air conditioner 1 adjusts the temperature of the air in an indoor space (not illustrated) to be conditioned, and serves as a heater or cooler as required. As illustrated in FIG. 1, the air conditioner 1 includes an outdoor unit 2 and an indoor unit 3. The air conditioner 1 also includes a pipe 4 between the outdoor unit 2 and the indoor unit 3. The pipe 4 allows refrigerant to flow therethrough and circulate between the outdoor unit 2 and the indoor unit 3.

As illustrated in FIG. 1, the outdoor unit 2 and the indoor unit 3 each include a heat exchanger 5 and a fan 6. The heat exchanger 5 causes heat exchange between refrigerant flowing through the heat exchanger 5 and the environment surrounding the heat exchanger 5. The fan 6 is a blower that sends the ambient air around the heat exchanger 5 to the heat exchanger 5, and thus facilitates the heat exchange.

As illustrated in FIG. 1, the outdoor unit 2 includes a compressor 7, a four-way valve 8, and an expansion valve 9. The compressor 7 performs adiabatic compression of refrigerant in a gas state. The four-way valve 8 switches the direction of refrigerant flow in the pipe 4. The expansion valve 9 reduces the pressure of refrigerant in a liquid state and thus evaporates the refrigerant.

In FIG. 1, the four-way valve 8 is turned into a mode in which the air conditioner 1 serves as a heater. In this mode, the refrigerant compressed by the compressor 7 and having an increased temperature flows into the heat exchanger 5 of the indoor unit 3, and discharges heat to the indoor air. The refrigerant that has flown through the heat exchanger 5 of the indoor unit 3 flows through the expansion valve 9 into the heat exchanger 5 of the outdoor unit 2, and absorbs heat from the outdoor air.

The refrigerant then returns to the compressor 7. When the four-way valve 8 is turned into another mode to reverse the direction of refrigerant flow, the refrigerant absorbs heat in the heat exchanger 5 of the indoor unit 3, and discharges heat in the heat exchanger 5 of the outdoor unit 2. The air conditioner 1 in this case serves as a cooler.

### Heat Exchanger

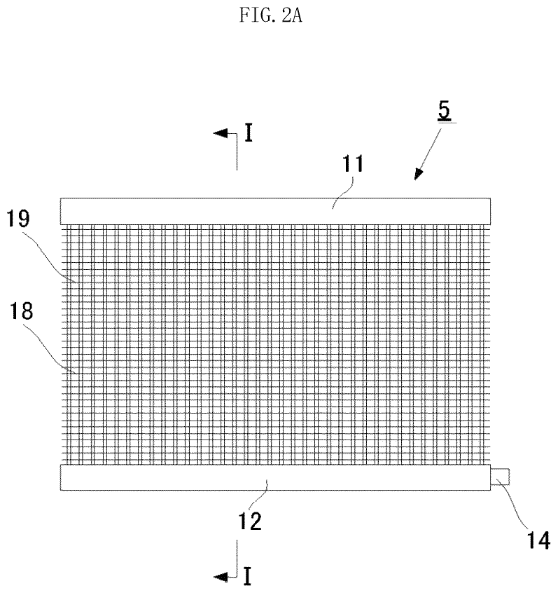

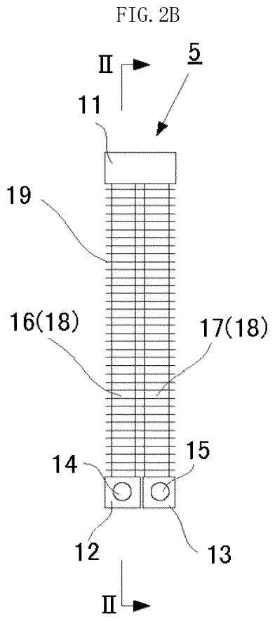

FIG. 2A is a front view illustrating a fundamental configuration of the heat exchanger 5, and FIG. 2B is a side view of the heat exchanger 5. As illustrated in FIGS. 2A and 2B, the heat exchanger 5 includes an upper header tube 11, a first lower header tube 12, and a second lower header tube 13.

As illustrated in FIG. 2B, the first lower header tube 12 has a first inlet/outlet port 14, whereas the second lower header tube 13 has a second inlet/outlet port 15. The first inlet/outlet port 14 and the second inlet/outlet port 15 are each a pipe joint connected to the pipe 4 (not illustrated in FIG. 2B). The first inlet/outlet port 14 and the second inlet/outlet port 15 allow refrigerant to enter or exit the heat exchanger 5. The first lower header tube 12 and the second lower header tube 13 have substantially the same structure, although this structure is not described in detail.

As illustrated in FIG. 2B, the first lower header tube 12 and the upper header tube 11 are provided with a first heat transfer tube array 16 therebetween, which couples the first lower header tube 12 to the upper header tube 11. The second lower header tube 13 and the upper header tube 11 are provided with a second heat transfer tube array 17 therebetween, which couples the second lower header tube 13 to the upper header tube 11.

As illustrated in FIG. 2A, the first heat transfer tube array 16 includes multiple heat transfer tubes 18 arranged at regular intervals in the longitudinal direction of the first lower header tube 12 and the upper header tube 11. The heat transfer tubes 18 have internal flow paths, which are not illustrated. These flow paths allow refrigerant to travel between the first lower header tube 12 and the upper header tube 11.

The second heat transfer tube array 17 also includes multiple heat transfer tubes 18 arranged at regular intervals in the longitudinal direction of the second lower header tube 13 and the upper header tube 11. The heat transfer tubes 18 also have internal flow paths, which allow refrigerant to travel between the second lower header tube 13 and the upper header tube 11.

As illustrated in FIGS. 2A and 2B, multiple heat transfer fins 19 are arranged at regular intervals between the upper header tube 11 and the first and second lower header tubes 12 and 13. The heat transfer fins 19 are made of thin metal plates and physically coupled to the first heat transfer tube array 16 and the second heat transfer tube array 17. The heat transfer fins 19 facilitate heat transfer between the ambient air and the refrigerant flowing in the first heat transfer tube array 16 and the second heat transfer tube array 17.

In an exemplary case where refrigerant enters the first lower header tube 12 via the first inlet/outlet port 14, the above-described structure allows the refrigerant that has entered the first lower header tube 12 to flow through the heat transfer tubes 18 of the first heat transfer tube array 16 to the upper header tube 11. The refrigerant that has arrived at the upper header tube 11 flows through the heat transfer tubes 18 of the second heat transfer tube array 17 to the second lower header tube 13. The refrigerant that has arrived at the second lower header tube 13 is released to the outside via the second inlet/outlet port 15. In another exemplary case where refrigerant enters the second lower header tube 13 via the second inlet/outlet port 15, the refrigerant travels in the route opposite to the above-described route, specifically, flows through the second heat transfer tube array 17, the upper header tube 11, and the first heat transfer tube array 16 in sequence, to the first lower header tube 12. The refrigerant that has arrived at the first lower header tube 12 is released to the outside via the first inlet/outlet port 14.

The refrigerant flowing through the heat exchanger 5 travels inside the heat transfer tubes 18, as described above. The refrigerant, while traveling inside the heat transfer tubes 18, exchanges heat with the ambient air around the heat exchanger 5. Upper header tube

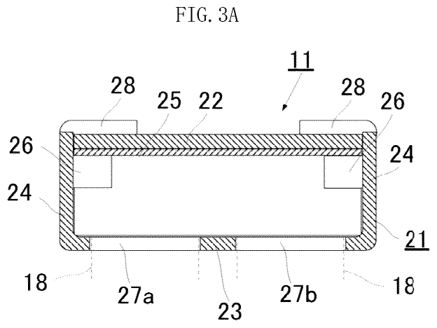

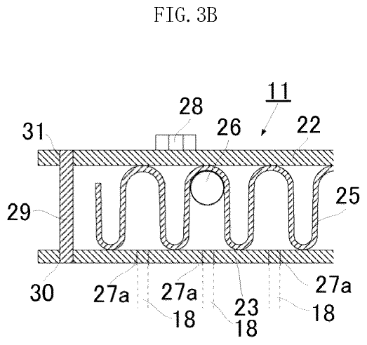

FIG. 3A is a transverse sectional view of the upper header tube 11 taken along the plane represented by the line I-I of FIG. 2A. FIG. 3B is a longitudinal sectional view of a part of the upper header tube 11 taken along the plane represented by the line II-II of

FIG. 2B. The upper header tube 11 is an example of a header tube according to the present disclosure, as described above.

As illustrated in FIG. 3A, the upper header tube 11 includes a first member 21 and a second member 22. The first member 21 and the second member 22 are bonded to each other by brazing. The first member 21 is a metal component including a bottom plate 23 and a pair of lateral plates 24 standing at opposed edges of the bottom plate 23. The first member 21 as a whole has a channel-shape defining a groove. The second member 22 is a metal component disposed at a position apart from the bottom plate 23 of the first member 21, and held between the pair of lateral plates 24 of the first member 21. In short, the second member 22 corresponds to a lid of the groove defined by the first member 21. As illustrated in FIG. 3A, the space inside the upper header tube 11, that is, the space defined between the first member 21 and the second member 22 accommodates a corrugated plate 25. The lateral plates 24 of the first member 21 are provided with protruding columns 26 having a cylindrical shape on the inner surfaces. The specific shapes and functions of the corrugated plate 25 and the protruding columns 26 are described below.

As illustrated in FIG. 3A, the bottom plate 23 of the first member 21 has

insertion holes 27a and 27b. The insertion holes 27a receive the respective ends of the heat transfer tubes 18 of the first heat transfer tube array 16, and are bonded to the ends by brazing. The insertion holes 27b receive the respective ends of the heat transfer tubes 18 of the second heat transfer tube array 17, and are bonded to the ends by brazing. As illustrated in FIG. 3A, the lateral plates 24 of the first member 21 each

have tab members 28 at the edge. The tab members 28 are bent relative to the lateral plates 24 so as to face the second member 22. The second member 22 is thus held between the corrugated plate 25 and the tab members 28.

As illustrated in FIG. 3B, the upper header tube 11 is provided with an end plate 29 adjacent to the left end in the longitudinal direction of the upper header tube 11. The bottom plate 23 and the second member 22 respectively have engaging holes 30 and 31, which receive the opposed edges of the end plate 29 fitted therein. FIG. 3B is a longitudinal sectional view of a part of the upper header tube 11 adjacent to the left end in FIG. 2A. The upper header tube 11 has a part adjacent to the right end having the same structure as the part adjacent to the left end. That is, the upper header tube 11 is provided with another end plate 29 adjacent to the right end in the longitudinal direction of the upper header tube 11.

The corrugated plate 25 is disposed between the first member 21 and the second member 22, as described above. The corrugated plate 25 has a wavy shape, as illustrated in FIG. 3B. This corrugated plate 25 divides the internal space of the upper header tube 11 into compartments each accommodating a pair of insertion holes 27a and 27b adjacent to each other. This structure causes the refrigerant that has entered the upper header tube 11 to travel within each of the compartments defined by the corrugated plate 25. For example, the refrigerant that has entered a certain compartment through the heat transfer tube 18 fixed to the corresponding insertion hole 27a flows into the heat transfer tube 18 fixed to the insertion hole 27b located adjacent to this insertion hole 27a, without flowing to the other compartments.

As illustrated in FIGS. 3A and 3B, the corrugated plate 25 meshes with the protruding columns 26, and is thus prevented from being displaced in the longitudinal direction of the upper header tube 11. The protruding columns 26 are designed to have a radius equal to the radius of curvature of curved portions of the corrugated plate 25, and arranged at the same pitch as those of the insertion holes 27a and 27b. The protruding columns 26 can thus align the corrugated plate 25 to the proper position relative to the insertion holes 27a and 27b just by meshing with the corrugated plate 25. The corrugated plate 25 holds the second member 22 against the tab members 28, as described above.

The upper header tube 11 may exclude the corrugated plate 25. The internal space of the upper header tube 11 may be divided into multiple compartments by multiple end plates 29, specifically, three or more end plates 29 arranged in the longitudinal direction of the upper header tube 11, so as to prevent the second member 22 from being displaced toward the bottom plate 23 of the first member 21 across the longitudinal direction of the upper header tube 11.

### First Member and Second Member

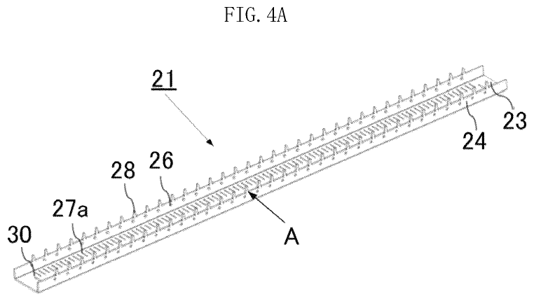

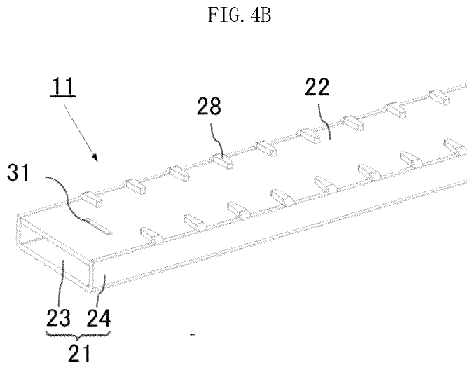

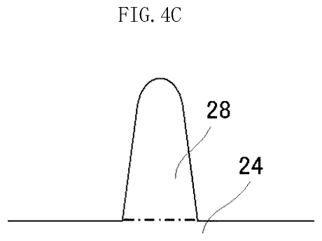

FIG. 4A is a perspective view illustrating the external shape of the first member 21 that constitutes the upper header tube 11. FIG. 4B is a perspective view of the first member 21 after fitting of the second member 22 to the first member 21. FIG. 4C is an enlarged view of one of the tab members 28 of the first member 21 as seen in the direction represented by the arrow A of FIG. 4A.

As illustrated in FIG. 4A, the lateral plates 24 of the first member 21 each have multiple tab members 28 at the edge. As illustrated in FIG. 4B, the second member 22 is fitted to the first member 21, followed by a step of bending the tab members 28 and thus bringing the tab members 28 into contact with the second member 22. As illustrated in FIG. 4C, each of the tab members 28 in plan view has the maximum width at the proximal portion, that is, the portion adjoining the lateral plate 24.

The tab member 28 is tapered toward the tip, that is, the portion most distant from the lateral plate 24. The tip of the tab member 28 is shaped to have an arc contour. The shape of the tab member 28 in plan view mentioned in this specification means the shape like that illustrated in FIG. 4C. The lengthwise direction of the tab member 28 indicates the direction from the proximal portion toward the tip of the tab member 28. The widthwise direction of the tab member 28 indicates the direction orthogonal to the lengthwise direction in the shape in plan view illustrated in FIG. 4C.

### Functions of Tab Members

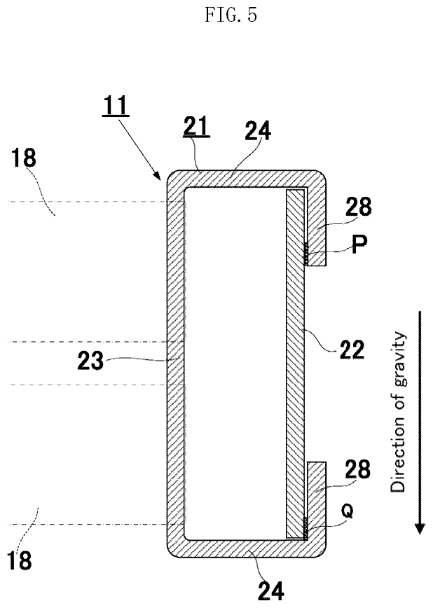

FIG. 5 is a transverse sectional view of the upper header tube 11. The following describes functions of the tab members 28 with reference to FIG. 5. The heat exchanger 5 is manufactured through assembling the components of the heat exchanger 5 with each other, heating the assembled components in a furnace, and then bonding the components to each other by brazing. In general, the heat exchanger 5 is laid down during the brazing process for the heat exchanger 5, because of the limited height of the furnace. That is, the heat exchanger 5 is subject to the brazing process in the furnace such that the longitudinal axes of the heat transfer tubes 18 are horizontally oriented. In short, the brazing process is applied to the heat exchanger 5 including the upper header tube 11 oriented as illustrated in FIG. 5. The first member 21 and the second member 22 are preliminarily provided with a brazing material cladded on their surfaces.

While the heat exchanger 5 is heated in a furnace, which is not illustrated, droplets of a molten brazing material in each of the gaps between the tab members 28 and the second member 22 located above in the first member 21 in FIG. 5 run downward due to gravity, to the tip of the tab member 28, that is, to the site represented by the reference symbol P in FIG. 5. Since the tab member 28 has a larger width at the proximal portion and a smaller width at the tip as described above, droplets of the brazing material residing in the proximal portion of the tab member 28 having a larger width run down and are concentrated at the tip of the tab member 28 having a smaller width. The concentrated droplets of the molten brazing material form a large lump at the tip of the tab member 28 and thicken the tip. This lump of the brazing material can be retained between the tip of the tab member 28 and the second member 22, even if the gap between the tip of the tab member 28 and the second member 22 is expanded by a springback behavior occurring after bending of the tab member 28. The brazing material, which is preliminarily cladded on the inner and outer surfaces of the second member 22 and the inner surface of the lateral plate 24, is molten by heating and infiltrates into the gap between the proximal portion of the tab member 28 and the second member 22, because of a capillary action generated at the gap. This brazing material fills the gap between the proximal portion of the tab member 28 and the second member 22, and the gap between the lateral plate 24 and the second member 22. The brazing material is thus sufficiently distributed across the joint between the first member 21 and the second member 22 located above in the first member 21. The capillary action draws the brazing material in the direction opposite to the direction of gravity, and thus gathers, to the gap, droplets of the brazing material residing in a large area around the gap between the first member and the second member.

In contrast, droplets of the molten brazing material in each of the gaps between the tab members 28 and the second member 22 located below in the first member 21 in FIG. 5 run downward due to gravity, to the site between the proximal portion of the tab member 28 and the second member 22, that is, the site represented by the reference symbol Q in FIG. 5. The droplets are then accumulated at this site. In general, the proximal portion of the tab member 28 defines a small gap against the second member 22 because the proximal portion of the tab member 28 is not readily affected by a deformation caused by a springback behavior. This small gap is filled with the run-off droplets of the brazing material. The capillary action causes the brazing material cladded on both surfaces of the lateral plate 24 to infiltrate into the gap between the first member 21 and the second member 22. The brazing material is thus also sufficiently distributed across the joint between the first member 21 and the second member 22 located below in the first member 21, as in the brazing material located above in the first member 21.

In order to obtain the above-described effects, that is, in order to distribute the brazing material across the gaps between the tab members 28 and the second member 22, performing bonding by brazing is required with the first member 21 and the second member 22 placed in a furnace such that the lengthwise direction of the tab member 28, that is, the direction from the proximal portion toward the tip of the tab member 28 is oriented vertically upward or vertically downward, as illustrated in FIG. 5. This orientation causes the gravity to act in the lengthwise direction of the tab member 28, and thus allows the brazing material to be sufficiently distributed across the gaps between the tab members 28 and the second member 22.

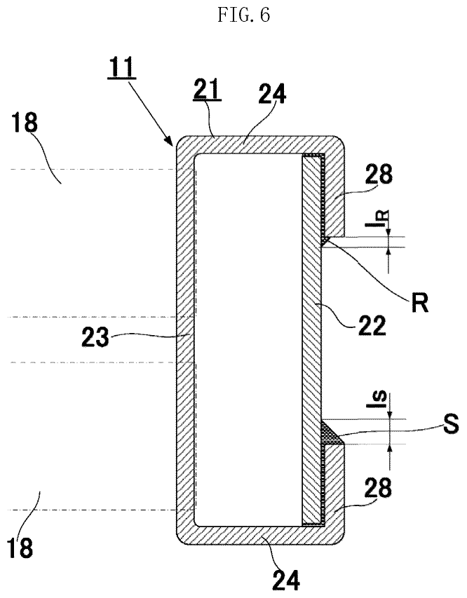

After completion of the brazing process involving the above-described steps, the gaps between the tab members 28 and the second member 22 are filled with the brazing material. As illustrated in FIG. 6, droplets of the brazing material are accumulated and then form fillets at the tips of the tab members 28, that is, the sites represented by the reference symbols R and S in FIG. 6. As illustrated in FIG. 6, the fillet formed at the site represented by the reference symbol S, that is, the fillet formed at the tip of the tab member 28 located below in the FIG. 6 is larger than the fillet formed at the site represented by the reference symbol R, that is, the fillet formed at the tip of the tab member 28 located above in FIG. 6. Specifically, an inequality I_{R}<I_{S} is satisfied, where I_{R} indicates the length of the fillet formed at the site represented by the reference symbol R, and I_{S} indicates the length of the fillet formed at the site represented by the reference symbol S. Such a difference in length is generated because the brazing material cladded on the outer surface of the second member 22 is molten, runs downward, and is then accumulated at the site represented by the reference symbol S.

As described above, a brazing material fillet formed at the tip of one of the

two tab members 28, which are opposed to each other in the transverse direction of the upper header tube 11, has a different size from a brazing material fillet formed at the tip of the other of the tab members 28, in this embodiment.

### Comparative Examinations

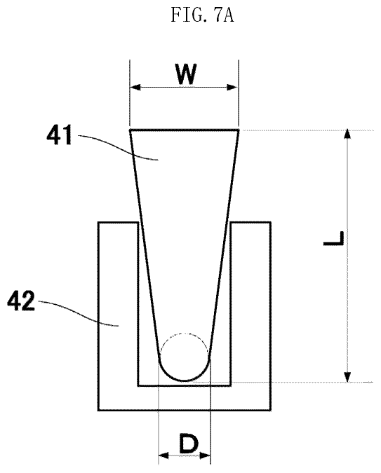

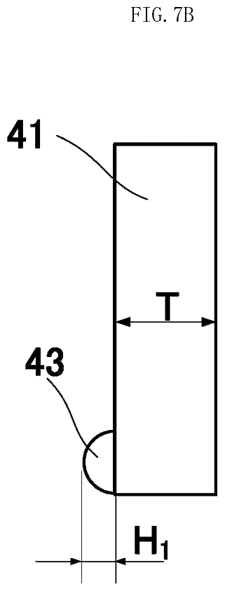

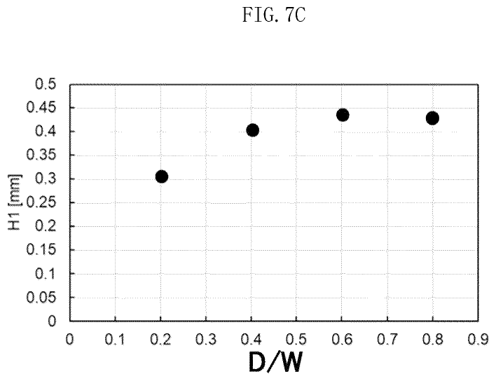

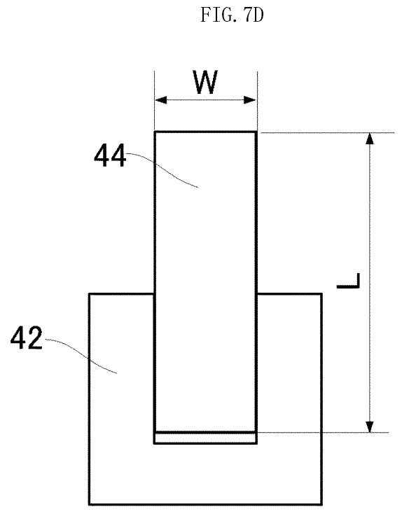

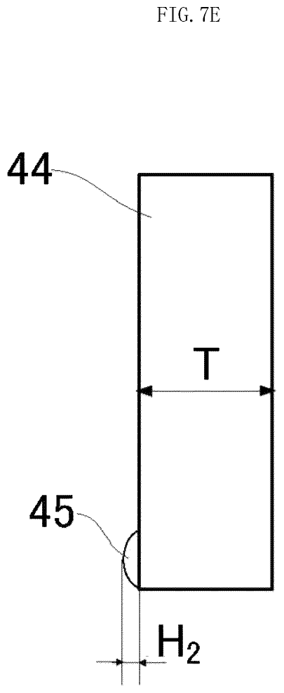

The functions and effects of the tab members 28 were verified through comparative examinations as described below. FIG. 7A is a front view illustrating the shapes of a test piece 41 that imitates the tab member 28 and a jig 42 that retains the test piece 41 before an examination. FIG. 7B is a side view illustrating the shape of the test piece 41 after the examination, that is, after a step of heating the test piece 41 in a furnace, which is not illustrated, and thus melting the brazing material.

The test piece 41 had a width W of 5 mm, a length L of 12 mm, and a thickness T of 3 mm, had smoothed surfaces, and was provided with a brazing material layer having a thickness of 0.15 mm. As illustrated in FIG. 7A, the test piece 41 had a semicircular tip. This examination involved comparison of the performances of test pieces 41 having different diameters D of the semicircular tips. Specifically, four types of test pieces 41 having diameters D of 1, 2, 3, and 4 mm were compared in terms of their performances. The jig 42 retained the test piece 41 in an upright orientation, while having no contact with the surfaces of the test piece 41. The jig 42 thus did not affect behaviors of the brazing material molten on the surfaces of the test piece 41.

As illustrated in FIG. 7B, droplets of the brazing material molten on the surface of the test piece 41 were concentrated at the tip of the test piece 41 having a smaller width and formed a lump 43. FIG. 7C illustrates a relationship between the value calculated by dividing the diameter D of the semicircular tip of the test piece 41 by the width W of the proximal portion of the test piece 41, that is, the ratio D/W and the measured height Hi of the lump 43 from the surface of the test piece 41, for each of the above-mentioned four types of test pieces 41. As illustrated in FIG. 7C, the height H1 of the lump 43 rose with an increase in the ratio D/W and reached 0.44 mm at the ratio D/W of 0.6, but lowered after the ratio D/W exceeded 0.6. That is, the maximum height H1 was achieved at the ratio D/W of 0.6. The lump 43 had a sufficient height when the ratio D/W was equal to or higher than 0.4, but suffered from an insufficient height when the ratio D/W was equal to or lower than 0.2. The diameters of 1, 2, 3, and 4 mm respectively provided the ratios D/W of 0.2, 0.4, 0.6, and 0.8, because the proximal portion of the test piece 41 used in this examination had a width W of 5 mm.

FIG. 7D is a front view illustrating the shapes of another test piece 44 according to a comparative example and the jig 42 before an examination. FIG. 7E is a side view illustrating the shape of the test piece 44 after the examination, that is, after a step of heating the test piece 44 in a furnace, which is not illustrated, and thus melting the brazing material. The test piece 44 had a width W of 5 mm, a length L of 12 mm, and a thickness T of 3 mm, had smoothed surfaces, and was provided with a brazing material layer having a thickness of 0.15 mm cladded on the surfaces. The test piece 44 was different from the test piece 41 in that the test piece 44 had a rectangular shape having a constant width W between the proximal portion and the tip. As illustrated in FIG. 7E, the brazing material molten on the surface of the test piece 44 ran downward to the tip of the test piece 44 and formed a lump 45. The formed lump 45, however, had a height H2 of only 0.36 mm from the test piece 44. The accumulated brazing material can be thickened by the ratio D/W equal to or higher than 0.4. The lump of the brazing material having a larger height can thus improve the capacity of brazing.

As described above, the test piece 41 was able to concentrate the molten brazing material at the tip of the test piece 41 having a smaller width, and thus form a lump 43 of the brazing material at the tip of the test piece 41 having a larger height than that of the lump 45 of the brazing material formed at the tip of the test piece 44 under the same heating conditions for the test pieces 41 and 44. This result demonstrates that the molten brazing material can be concentrated at the tip of the tab member 28 and have a larger height, if the tab member 28 is designed to be tapered toward the tip in plan view.

At the ratio D/W equal to or higher than 0.4, the brazing material is successfully concentrated at the tip of the tab member and accumulated into a large thickness. In contrast, at the ratio D/W equal to or lower than 0.2, droplets of the brazing material are accumulated also in an area closer to the proximal portion of the tab member and results in a relatively smaller thickness, because of an excessively small width of the tip of the tab member.

### Modifications 1 and 2

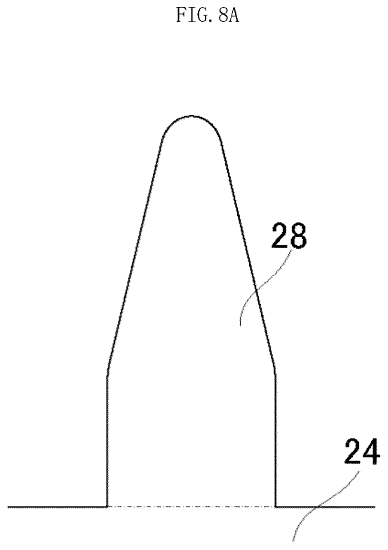

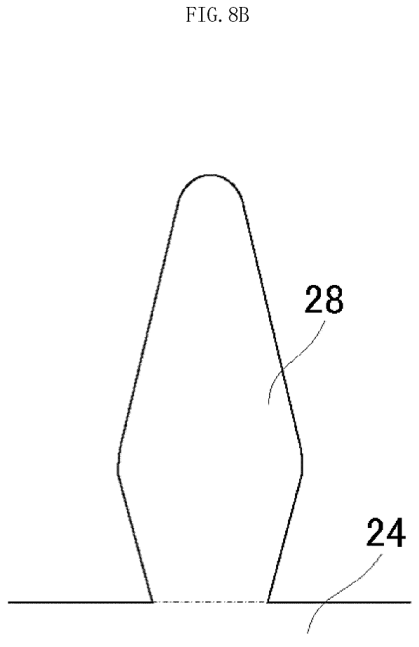

FIG. 8A is a plan view illustrating the shape of a tab member 28 according to Modification 1 of the present disclosure. As illustrated in FIG. 8A, the tab member 28 may have a constant width in a certain area from the proximal portion adjoining the lateral plate 24 to a middle portion, and may be gradually tapered from the middle portion toward the tip having the minimum width.

FIG. 8B is a plan view illustrating the shape of a tab member 28 according to Modification 2 of the present disclosure. As illustrated in FIG. 8B, the tab member 28 may have a smaller width at the proximal portion adjoining the lateral plate 24, be widen from the proximal portion to a middle portion, and then be gradually tapered toward the tip having the minimum width. That is, the tab member 28 may have a constricted proximal portion in plan view.

### Modification 3

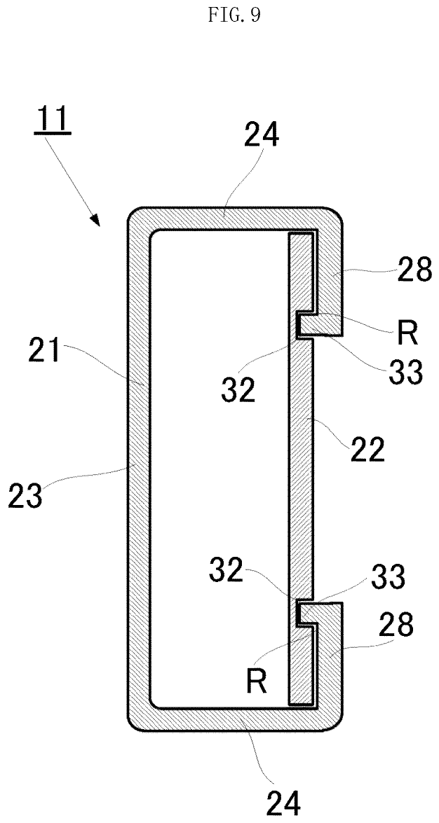

FIG. 9 is a transverse sectional view illustrating the structure of an upper header tube 11 according to Modification 3 of the present disclosure in conformity with FIG. 5. As illustrated in FIG. 9, the upper header tube 11 has recesses 32 on the second member 22, and protrusions 33 at the tips of the tab members 28. The protrusions 33 are fitted in the respective recesses 32. This structure facilitates droplets of a molten brazing material to be accumulated in crank-shaped gaps R between the protrusions 33 and the recesses 32 in the brazing process. These droplets of the brazing material accumulated in the gaps R are distributed across the gaps between the first member 21 and the second member 22 due to a capillary action. The distributed brazing material can prevent a crack from being generated at the brazed joint between the first member 21 and the second member 22.

### Modification 4

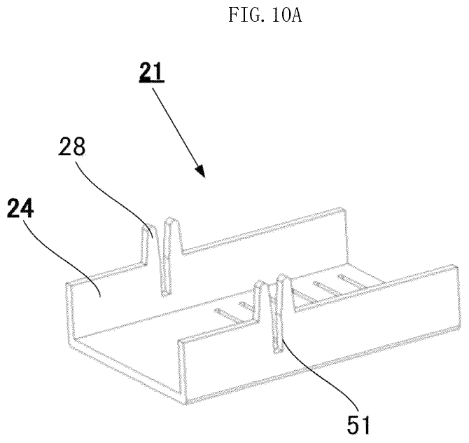

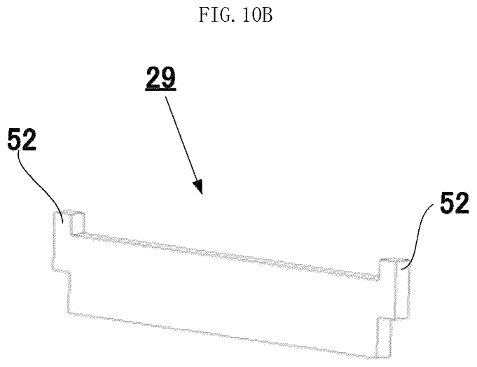

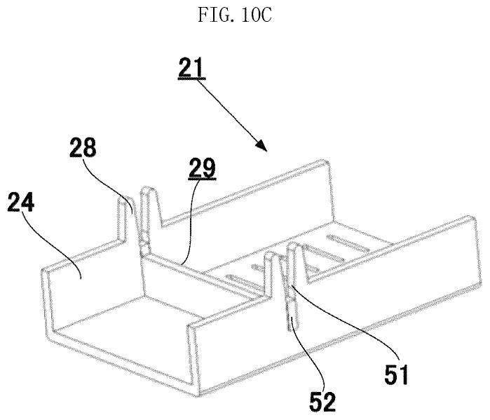

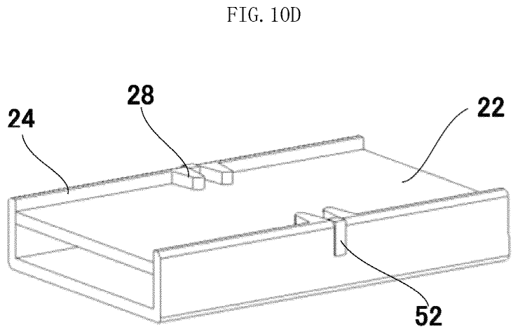

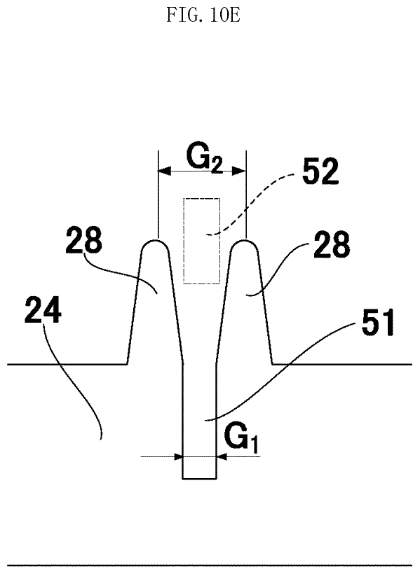

FIG. 10A is a perspective view illustrating the shape of a first member 21 according to Modification 4. FIG. 10B is a perspective view illustrating the shape of an end plate 29 according to Modification 4. FIG. 10C is a perspective view of the first member 21 after fitting of the end plate 29 to the first member 21. FIG. 10D is a perspective view of the first member 21 after fitting of the end plate 29 and a second member 22 to the first member 21 and bending of tab members 28. FIG. 10E is an explanatory diagram illustrating the shapes of the tab members 28 and an engaging notch 51 of the first member 21 according to Modification 4, in conformity with FIG. 4C. Although the end plate 29 is fitted in the upper header tube 11 by engaging the edges of the end plate 29 with the engaging holes 30 and 31 of the bottom plate 23 and the second member 22 in the above-described example, the end plate 29 may also be fitted in the upper header tube 11 by a procedure other than the engaging holes 30 and 31. The engaging holes 30 and 31 may be replaced with engaging notches 51 provided to the edges of the two lateral plates 24 opposed to each other. As illustrated in FIG. 10A, the engaging notches 51 are each located between two tab members 28 adjacent to each other in the longitudinal direction of the first member 21 and extend from the edge of the lateral plate 24. As illustrated in FIG. 10B, the end plate 29 has ears 52 at the opposed edges. As illustrated in FIG. 10C, the ears 52 are inserted in the respective engaging notches 51 and engaged with the engaging notches 51, so that the end plate 29 is align to the proper position relative to the first member 21. As illustrated in FIG. 10D, the end plate 29 is covered with the second member 22, followed by a step of bending the tab members 28. These steps can fix the end plate 29 to the first member 21 and the second member 22.

As illustrated in FIG. 10E, the engaging notches 51 have a width G₁ equal to the distance between the two tab members 28 at the proximal portions. Since each of the tab members 28 is tapered toward the tip, as described above, the two tab members 28 at the tips have a distance G₂ therebetween larger than the distance between the two tab members 28 at the proximal portions. The distance G₂ is thus larger than the thickness of the end plate 29. The tab members 28 having this structure can guide the ears 52 of the end plate 29 to be inserted in the engaging notches 51. The ears 52 can therefore be readily inserted in the engaging notches 51.

### Modification 5

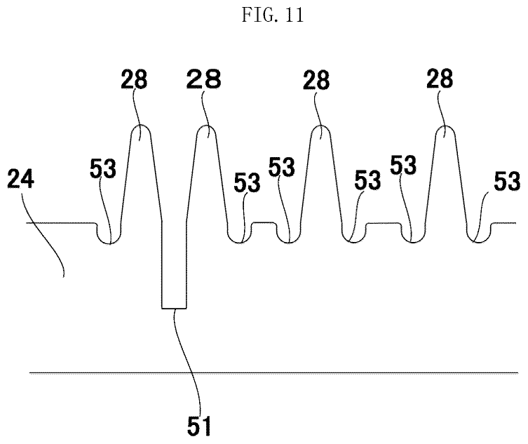

FIG. 11 is an explanatory diagram illustrating the shapes of tab members 28 and notches 53 of a first member 21 according to Modification 5, in conformity with FIG. 4C. The junction between the lateral plate 24 and each of the tab members 28 may have a shape other than that illustrated in FIG. 4C. As illustrated in FIG. 11, the proximal portion of the tab member 28 and the lateral plate 24 may be provided with the notches 53 therebetween to achieve structural “separation” of the tab member 28 from the lateral plate 24. Such structural “separation” of the tab member 28 from the lateral plate 24 can reduce a springback behavior occurring after bending of the tab member 28. That is, this structure can prevent the bent tab member 28 from deforming back to the original shape due to the resilience of the material of the tab member 28 and thus expanding the gap between the tab member 28 and the second member. The structure can therefore improve the structural stability of the upper header tube 11.

As described above, even in the case where relatively-small gaps are defined between the tab members 28 and the second member 22, these gaps retain droplets of a brazing material molten in the brazing process. The retained droplets of the brazing material are sequentially distributed across the joint between the first member 21 and the second member 22 due to a capillary action, and accumulated at the joint. The distributed brazing material can prevent a crack from being generated at the brazed joint between the first member 21 and the second member 22. This upper header tube 11 can readily achieve a sufficiently airtight structure in the manufacturing process.

The above-described embodiments are not to be construed as limiting the technical scope of the present disclosure. The present disclosure may be arbitrarily applied, modified, or revised without departing from the technical idea recited in the claims.

The header tube according to the present disclosure may have a specific mechanical structure other than the above-described specific structure of the upper header tube 11. Specifically, the header tube according to the present disclosure does not necessarily include the corrugated plate 25. The tab members included in the header tube according to the present disclosure may have a specific shape other than the above-described specific shapes of the tab members 28.

The heat exchanger according to the present disclosure may have a specific structure other than the above-described specific structure of the heat exchanger 5. Specifically, the heat exchanger according to the present disclosure does not necessarily include both of the first lower header tube 12 and the second lower header tube 13. The two header tubes in the heat exchanger according to the present disclosure are not necessarily disposed apart from each other in the vertical direction. The two header tubes in the heat exchanger according to the present disclosure may also be disposed apart from each other in the horizontal direction. In the heat exchanger according to the present disclosure, only at least one of multiple header tubes is required to be the header tube according to the present disclosure.

The air conditioner according to the present disclosure may have a specific

structure other than the above-described specific structure of the air conditioner 1. In the air conditioner according to the present disclosure, only either one of the indoor unit and the outdoor unit is required to include the above-described heat exchanger according to the present disclosure. The other of the indoor unit and the outdoor unit may include another type of heat exchanger. Alternatively, the air conditioner according to the present disclosure may include components not demonstrated in the above description.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-037966, filed on Mar. 11, 2022, the entire disclosure of which is incorporated by reference herein.

### Reference Signs List

1 Air conditioner

2 Outdoor unit

3 Indoor unit

4 Pipe

5 Heat exchanger

6 Fan

7 Compressor

8 Four-way valve

9 Expansion valve

11 Upper header tube

12 First lower header tube

13 Second lower header tube

14 First inlet/outlet port

15 Second inlet/outlet port

16 First heat transfer tube array

17 Second heat transfer tube array

18 Heat transfer tube

19 Heat transfer fin

21 First member

22 Second member

23 Bottom plate

24 Lateral plate

25 Corrugated plate

26 Protruding column

27a, 27b Insertion hole

28 tab member

29 End plate

30, 31 Engaging hole

32 Recess

33 Protrusion

41, 44 Test piece

42 Jig

43, 45 Lump

51 Engaging notch

52 Ear

53 Notch

1. A header tube connectable to heat transfer tubes arranged in parallel to each other, the header tube being capable of constituting a heat exchanger together with the heat transfer tubes, the header tube comprising:
a first member that includes
a bottom plate, and
a pair of lateral plates standing at opposed edges of the bottom plate, and has a channel section defining a groove;
a second member that has a tabular shape, the second member being disposed apart from the bottom plate, held between the pair of lateral plates, and bonded to the first member by brazing, so as to be a lid of the groove defined by the channel section; and
tab members disposed at edges of the pair of lateral plates of the first member, the tab members being bent relative to the lateral plate so as to face the second member, wherein
each of the tab members is tapered toward a tip in plan view, and
a gap between the second member and the tab members and a gap between the second member and the lateral plates of the first member are filled with a brazing material.

2. The header tube according to claim 1, wherein
the tab members have, at the tips, protrusions protruding toward the second member,
the second member has recesses, and
the protrusions are fitted in the respective recesses.

3. The header tube according to claim 1, wherein each of the tab members is tapered from a middle portion in a lengthwise direction of the tab member toward the tip.

4. The header tube according to claim 1, wherein each of the tab members is widen from a proximal portion to a middle portion in a lengthwise direction of the tab member, and tapered from the middle portion toward the tip, the proximal portion of the tab member adjoining the lateral plate.

5. The header tube according to claim 1, further comprising:
an end plate for closing an end of the header tube in a longitudinal direction of the header tube, wherein
the first member has engaging notches extending from the edges of the pair of lateral plates, each of the engaging notches being disposed between mutually adjacent two of the tab members, and
the end plate partially engages with the engaging notches.

6-9. (canceled)

10. A header tube connectable to heat transfer tubes arranged in parallel to each other, the header tube being capable of constituting a heat exchanger together with the heat transfer tubes, the header tube comprising:
a first member including
a bottom plate, and
a pair of lateral plates standing at opposed edges of the bottom plate;
a second member disposed apart from the bottom plate, held between the pair of lateral plates, and bonded to the first member by brazing; and
tab members disposed at edges of the pair of lateral plates of the first member, the tab members being bent relative to the lateral plate so as to face the second member, wherein
each of the tab members is tapered toward a tip in plan view,
the header tube further comprises a partition plate for dividing an internal space of the header tube,
the first member has engaging notches extending from the edges of the pair of lateral plates, each of the engaging notches being disposed between mutually adjacent two of the tab members, and
the partition plate partially engages with the engaging notches.

11. The header tube according to claim 1, wherein a brazing material fillet formed at a tip of one of two tab members has a different size from a brazing material fillet formed at a tip of the other of the two tab members, the two tab members being opposed to each other in a transverse direction of the header tube.

12. The header tube according to claim 1, further comprising:
an end plate for closing an end of the header tube, the end plate being fixed to the first member and the second member.

13. The header tube according to claim 1, further comprising:
a partition plate for dividing an internal space of the header tube, the partition plate being fixed to the first member and the second member.

14. The header tube according to claim 13, wherein
the lateral plates have engaging notches, and
the partition plate engages with the engaging notches.

15. The header tube according to claim 1, wherein the edges of the lateral plates are notched at portions adjacent to proximal portions of the tab members so as to form notches.

16. The header tube according to claim 1, wherein the tip of each of the tab members has an arc contour in plan view.

17. The header tube according to claim 16, wherein D/W is equal to or higher than 0.4 and is lower than or equal to 0.8, where D represents a diameter of the arc contour that the tip of each of the tab members has in plan view and W represents a width of a proximal portion of each of the tab members.

18. The header tube according to claim 1, wherein the tab members are bent so as to be perpendicular to the lateral plates.

19. A heat exchanger, comprising:
the header tube according to claim 1; and
heat transfer tubes connected to the header tube.

20. An air conditioner comprising an indoor unit and an outdoor unit, the air conditioner being configured to cause refrigerant to circulate between the indoor unit and the outdoor unit, wherein
at least either of the indoor unit and the outdoor unit includes the heat exchanger according to claim 19.

21. A method of manufacturing a header tube connectable to heat transfer tubes arranged in parallel to each other, the header tube being capable of constituting a heat exchanger together with the heat transfer tubes, the header tube including
a first member including
a bottom plate, and
a pair of lateral plates standing at opposed edges of the bottom plate,
a second member disposed apart from the bottom plate, held between the pair of lateral plates, and bonded to the first member by brazing, and
tab members disposed at edges of the pair of lateral plates of the first member, the tab members being bent relative to the lateral plate so as to face the second member,
each of the tab members being tapered toward a tip in plan view,
a gap between the second member and the tab members and a gap between the second member and the lateral plates of the first member being filled with a brazing material, the method comprising:
fitting the second member to the first member, and then performing bonding by brazing, with the first member and the second member placed in a furnace such that a direction from a proximal portion to the tip of each of the tab members is oriented vertically upward or vertically downward.
